(19) United States
(12) Patent Application Publication
(10) Pub. No.: US 2020/0048096 A1
(43) Pub. Date: Feb. 13, 2020

(54) METHOD FOR PREPARING GRAPHENE OXIDE QUANTUM DOTS IN A LARGE SCALE WITH CRYPTOCRYSTALLINE GRAPHITE

(71) Applicant: UNIVERSITY OF SHANGHAI FOR SCIENCE AND TECHNOLOGY, Shanghai (CN)

(72) Inventors: Shuling SHEN, Shanghai (CN); Junhe YANG, Shanghai (CN)

(21) Appl. No.: 16/498,355

(22) PCT Filed: Mar. 27, 2018
(86) PCT No.: PCT/CN2018/080593

§ 371 Date: Sep. 26, 2019

(30) Foreign Application Priority Data
Mar. 28, 2017 (CN) 201710192480.X

(51) Int. Cl. C01B 32/198

(52) U.S. Cl. CPC C01B 32/198; B82Y 30/00

(57) ABSTRACT

The invention discloses a method for preparing graphene oxide quantum dots in a large scale with cryptocrystalline graphite, comprising the following steps: mixing a certain amount of cryptocrystalline graphite powder, sodium nitrate, and sulfuric acid with ultrasonic treating; stirring the solution for 1-3 hours in ice-water bath; adding a certain amount of potassium permanganate, and mixing while stirring, then increasing temperature; adding deionized water, increasing the temperature and maintain for 1-3 hours, then diluting with water and adding a certain amount of hydrogen peroxide, stirring followed by standing and staying overnight; adding hydrochloric solution; adding water into the solution, implementing centrifugal clean till the pH value equals 7, and implementing centrifugally ultrasonic treatment, thereby obtain the graphene oxide quantum dot. According to the method of the invention, the raw materials are abundant and low in cost; the process is simple; the acquired graphene oxide quantum dots is high in yield and uniform in size; the graphene oxide quantum dots can be applied in fields such as catalysis, bio-labeling and electronic image.

### TECHNICAL FIELD

The present invention belongs to material science, and in particular relates to a method for preparing graphene oxide quantum dots in a large scale with cryptocrystalline graphite.

### TECHNICAL BACKGROUND

Quantum dots refers to nano-materials which have a three-dimensional size in nanoscale (less than 100 nm), and are composed of finite number of atoms. Due to its small size, quantum dots have quantum confinement effect and thus have some excellent properties. Compared with the traditional semiconductor quantum dots, graphene quantum dots have characteristics as good biocompatibility, low toxicity and easiness for surface modification, which can be used in fields of catalysis, biomarkers and electronic imaging, etc., and have now become the hot topics in carbon nanomaterial research.

At present, there are many preparation methods of graphene quantum dots, such as arc exothermic method, laser method, electrochemical oxidation method, combustion thermal decomposition method, microwave method and the like. These methods usually have complicated processes, high cost, and very low yield. Compared with the above methods, it is simpler and more convenient by using graphene oxide as a precursor and followed by deoxidization so as to obtain the graphene quantum dots. Li et al. prepared graphene quantum dots by microwave method (Advanced Functional Materials, 2012, 22 (14): 2971-2979.). However, this method has high requirements on instruments and is not easy for implementation. Pan et al. (Journal of Materials Chemistry, 2012, 22 (8): 3314-3318.) prepared graphene quantum dots by following steps: exfoliating flaky graphite by intercalation so as to obtain graphene oxide, followed by chemical shearing through strong acid, and subjected to calcination reduction at high temperature.

However, this process requires to use strong acid for many times, thus has great processing difficulty and high risk. He Peng et al. (Patent No. 104045076A) prepared graphene oxide quantum dots by using citric acid as a precursor and blending with concentrated sulfuric acid for hydrothermal process. The resulted sample needs to be ultrafiltrated, dialyzed, and purified with special reagents. The above processes either have high requirements on the instrument, or repeatedly use strong acid shearing, or need for post-purification, which is high in cost and energy consumption, but is low in the yield of graphene quantum dots.

### SUMMARY OF INVENTION

In view of the above technical problems in the current methods, the present invention provides a method for preparing graphene oxide quantum dots in large scale with cryptocrystalline graphite. Said method for preparing graphene oxide quantum dots is to solve the technical problems in the current methods such as complicated processes and steps, high cost and high energy consumption, and low yield.

The present invention provides a method for preparing a graphene oxide quantum dots in a large scale with cryptocrystalline graphite, comprising the following steps:

1) weighing cryptocrystalline graphite powder and sodium nitrate with a mass ratio of cryptocrystalline graphite powder to sodium nitrate from 5:1 to 1:5, and weighing sulfuric acid solution having a concentration of 10˜98 wt %, wherein the volume-to-mass ratio of the sulfuric acid solution to the graphite powder is 30˜10 ml: 1 g;

2) ultrasonically mixing said graphite powder, the sodium nitrate and the sulfuric acid for 20 minutes to 3 hours, preferably 0.5 to 3 hours, the resulted mixture being transferred into ice-water bath for stirring for 0.5 to 3 hours, preferably 1 to 3 hours;

3) adding potassium permanganate while stirring and keeping temperature rising, the mass ratio of said potassium permanganate to cryptocrystalline graphite powder being from 5:1 to 1:3;

4) adding deionized water by drops and then raising the temperature, the mass ratio of the deionized water to cryptocrystalline graphite powder being 20˜60:1;

5) the resulted mixture is diluted with water to 2 to 5 times of the original volume and is added with hydrogen peroxide, followed by mixing and stirring, then is left for standing and staying overnight, the mass ratio of hydrogen peroxide to cryptocrystalline graphite powder being 1-4:1;

6) removing the supernatant, adding hydrochloric solution till evenly mixed, and implementing centrifugal clean till the pH value being 7, the volume-to-mass ratio of the added hydrochloric acid solution to cryptocrystalline graphite powder being 3˜5 ml: 1 g;

7) the solution obtained in step 6) is subjected to ultrasonic treatment at low temperature, and centrifugation treatment, so as to obtain the graphene oxide quantum dots.

Further, the cryptocrystalline graphite powder is in a form of granular having a particle size of 1 to 25 microns.

Further, the ice-water bath temperature is 0 to 10° C.

Further, the addition of potassium permanganate is completed within a period time of 0.5 to 2 hours, and the temperature being raised to 10˜90° C.

Further, in step 4), deionized water is added, the temperature is raised to 10 to 100° C., and held for 0.5 to 3 hours.

Further, in step 6), the centrifugal treatment is carried out at a rate of 3000 rpm to 20000 rpm and for 10 to 60 minutes.

Further, in step 7), the ultrasonic treatment is carried out at temperature of 0 to 60° C. for 0.5 to 10 hours.

Further, the hydrogen peroxide has a concentration of 10% to 70% by mass.

Further, the hydrochloric acid has a concentration of 5% to 30% by mass.

Compared with the current methods, the present invention has remarkable technological advancement. The cryptocrystalline graphite powder is cheap and readily available as raw materials of the present invention. The preparation process is simple and easy to operate. The prepared graphene oxide quantum dots are uniform in size, have high yield and high quality, and can be used in fields of catalysis, biomarker and electronic image.

### DESCRIPTION OF DRAWINGS

FIG. 1 is a scanning electron microscope (SEM) photograph of cryptocrystalline graphite powder of Example 1.

FIG. 2 is a transmission electron micrograph (TEM) of graphene oxide quantum dots prepared by the method of the present invention.

FIG. 3 is a UV absorption spectrum and a fluorescence spectrum of the graphene oxide quantum dots prepared by the method of the present invention in Example 1.

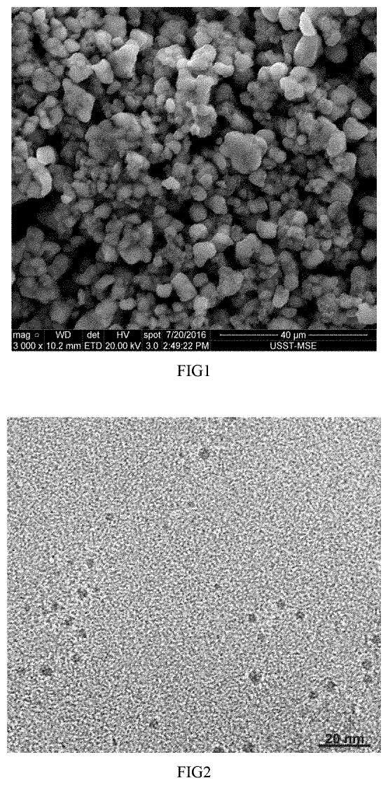

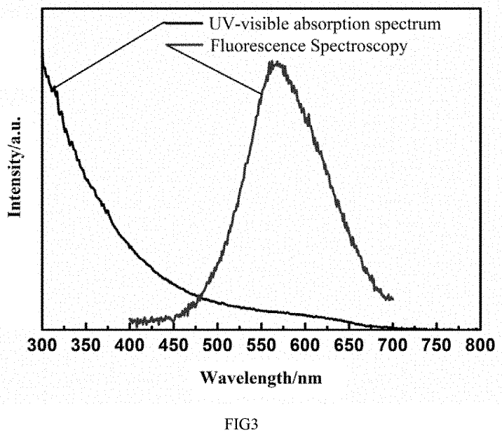

### DETAILED EMBODIMENTS

In order to illustrate the technical means, the inventive features, the object and the effect achieved by the present invention clearly, the following specific embodiments of the method for preparing the graphene oxide quantum dots according to the present invention are specifically illustrated in the following embodiments with reference to the drawings.

### Example 1

5 gram of cryptocrystalline graphite powder and 2 gram of sodium nitrate were weighed and added into 120 ml of concentrated sulfuric for thoroughly ultrasonic mixing for 20 minutes. The resulted mixture was transferred to an ice-water bath for stirring at a constant temperature for 30 minutes. The above solution was added with 15 g potassium permanganate slowly while temperature increasing to 35° C., and was magnetic stirred for 45 minutes. Then the solution was added with 200 ml of deionized water, heated to 98° C., and was subjected to magnetic stirring for 45 minutes. Then the solution was diluted with water, added with 10 ml of hydrogen peroxide and stirred thoroughly, the solution was then left for standing and staying overnight. The supernatant of the solution was removed, then 20 ml of hydrochloric solution of 20 vt % was added into the solution, followed by magnetic stirring at room temperature for 30 minutes. Centrifugal clean at 11000 rpm was implemented for 10 minutes and the supernatant was removed, and the precipitate was washed repeated until the pH value of supernatant is 7. The slurry obtained was subjected to ultrasonic treatment at low temperature for 2 hours, centrifuged at 3000 r so as to remove the non-oxidized graphite, then the solution was centrifugal separated so as to obtain graphene oxide quantum dots, which were then bottled standby.

In a preferred embodiment of the present invention, the sulfuric acid is preferably at a concentration of 98% by mass.

Further, the said hydrogen peroxide has a concentration of 10% to 70% by mass.

Further, the said hydrochloric acid has a concentration of 5% to 30% by mass.

### Example 2

1 gram of cryptocrystalline graphite powder and 0.5 gram of sodium nitrate were weighed and added into 100 ml of concentrated sulfuric for thoroughly ultrasonic mixing for 30 minutes. The resulted mixture was transferred to an ice-water bath for stirring at a constant temperature for 30 minutes. The above solution was added with 5 g potassium permanganate slowly while temperature increasing to 60° C., and was magnetic stirred for 45 minutes. Then the solution was added with 200 ml of deionized water, heated to 80° C., and was subjected to magnetic stirring for 45 minutes. Then the solution was diluted with water, added with 15 ml of hydrogen peroxide and stirred thoroughly, the solution was then left for standing and staying overnight. The supernatant of the solution was removed, then 50 ml of hydrochloric solution of 30 vt % was added into the solution, followed by magnetic stirring at room temperature for 30 minutes. Centrifugal clean at 11000 rpm was implemented for 10 minutes and the supernatant was removed, and the precipitate was washed repeated until the pH value of supernatant is 7. The obtained slurry was subjected to ultrasonic treatment at low temperature for 2 hours, and centrifuged at 3000 rpm to remove the non-oxidized graphite. The solution was centrifugal separated so as to obtain graphene oxide quantum dots, which were then bottled standby.

In a preferred embodiment of the present invention, the sulfuric acid is preferably at a concentration of 98% by mass.

Further, the said hydrogen peroxide has a concentration of 10% to 70% by mass.

Further, the said hydrochloric acid has a concentration of 5% to 30% by mass.

### Example 3

5 gram of cryptocrystalline graphite powder and 5 gram of sodium nitrate were weighed and added into 200 ml of concentrated sulfuric for thoroughly ultrasonic mixing for 40 minutes. The resulted mixture was transferred to an ice-water bath for stirring at a constant temperature for 30 minutes. The above solution was added with 20 g potassium permanganate slowly while temperature increasing to 40° C., and was magnetic stirred for 60 minutes. Then the solution was added with 250 ml of deionized water, heated to 100° C., and was subjected to magnetic stirring for 45 minutes. Then the solution was diluted with water, added with 20 ml of hydrogen peroxide and stirred thoroughly, the solution was then left for standing and staying overnight. The supernatant of the solution was removed, then 20 ml of hydrochloric solution of 10 vt % was added into the solution, followed by magnetic stirring at room temperature for 30 minutes. Centrifugal clean at 11000 rpm was implemented for 10 minutes and the supernatant was removed, and the precipitate was washed repeated until the pH value of supernatant is 7. The solution obtained was subjected to ultrasonic treatment at low temperature for 3 hours, and centrifuged at 3000 rpm to remove the non-oxidized graphite. The solution was centrifugal separated so as to obtain graphene oxide quantum dots, which were then bottled standby.

In a preferred embodiment of the present invention, the sulfuric acid is preferably at a concentration of 98% by mass.

Further, the said hydrogen peroxide has a concentration of 10% to 70% by mass.

Further, the said hydrochloric acid has a concentration of 5% to 30% by mass.

The method for preparing graphene oxide quantum dots in large scale with cryptocrystalline graphite is featured by simple processing, conditions being easy to realize, raw materials of low cost and easy availability. The acquired graphene oxide quantum dots are high yield and uniform in size. Therefore, the present invention effectively overcomes various limitations in the current methods and has industrial utility value.

The above examples merely illustrate the principle and effect of the present invention, but are not intended to limit the present invention. Any person skilled in the art may make modifications or changes to the above embodiments without departing from the spirit and scope of the present invention. Therefore, all equivalent modifications or changes made by those skilled in the art without departing from the spirit and technical idea disclosed in the present invention should still be covered by the claims of the present invention.

1. A method for preparing a graphene oxide quantum dot in a large scale with cryptocrystalline graphite, comprising the following steps:
1) weighing cryptocrystalline graphite powder and sodium nitrate with a mass ratio of cryptocrystalline graphite powder to sodium nitrate from 5:1 to 1:5, and weighing sulfuric acid solution having a concentration of 10˜98%, wherein the volume-to-mass ratio of the sulfuric acid solution to the graphite powder is 30˜10 ml: 1 g;
2) ultrasonically the mixture of cryptocrystalline graphite, sodium nitrate and sulfuric acid for 20 minutes to 3 hours, the resulted mixture being transferred into ice-water bath for stirring for 0.5 to 3 hours;
3) adding potassium permanganate while stirring and keeping temperature rising, the mass ratio of said potassium permanganate to cryptocrystalline graphite powder being from 5:1 to 1:3;
4) adding deionized water by drops and then raising the temperature, the mass ratio of the deionized water to cryptocrystalline graphite powder being 20˜60:1;
5) the resulted mixture is diluted with water to 2 to 5 times of the original volume and is added with hydrogen peroxide, followed by mixing and stirring, then is left for standing and staying overnight, the mass ratio of hydrogen peroxide to cryptocrystalline graphite powder being 1 to 4:1;
6) removing the supernatant, adding hydrochloric solution till evenly mixed, and implementing centrifugal clean till the pH value being 7, the volume-to-mass ratio of the added hydrochloric acid solution to cryptocrystalline graphite powder being 3˜5 ml: 1 g;
7) the solution obtained in step 6) is subjected to ultrasonic treatment at low temperature, and centrifugation treatment, so as to obtain the graphene oxide quantum dots.

2. The method for preparing a graphene oxide quantum dots in a large scale with cryptocrystalline graphite according to claim 1, wherein the cryptocrystalline graphite powder is in a form of granular having a particle size of 1 to 25 microns.

3. The method for preparing a graphene oxide quantum dots in a large scale with cryptocrystalline graphite according to claim 1, wherein the temperature of the ice-water bath is 0 to 10° C.

4. The method for preparing a graphene oxide quantum dots in a large scale with cryptocrystalline graphite according to claim 1, wherein the addition of potassium permanganate is completed within a period of 0.5 to 2 hours, and the temperature being raised to 10 to 90° C.

5. The method for preparing a graphene oxide quantum dot in a large scale with cryptocrystalline graphite according to claim 1, wherein in step 4), adding deionized water, the temperature being raised to 10˜100° C., and being held for 0.5 to 3 hours.

6. The method for preparing a graphene oxide quantum dot in a large scale with cryptocrystalline graphite according to claim 1, wherein in step 6), the centrifugal treatment is carried out at a rate of 3000 rpm to 20000 rpm and for 10 to 60 minutes.

7. The method for preparing a graphene oxide quantum dot in a large scale with cryptocrystalline graphite according to claim 1, wherein in step 7), the ultrasonic treatment is carried out at temperature of 0˜60° C. for 0.5 to 10 hours.

8. The method for preparing a graphene oxide quantum dot in a large scale with cryptocrystalline graphite according to claim 1, wherein the hydrogen peroxide has a concentration of 10% to 70% by mass.

9. The method for preparing a graphene oxide quantum dot in a large scale with cryptocrystalline graphite according to claim 1, wherein the hydrochloric acid has a concentration of 5% to 30% by mass.
